(19) United States
(12) Patent Application Publication
(10) Pub. No.: US 2008/0063444 A1
(43) Pub. Date: Mar. 13, 2008

(54) FIXING MEMBER AND IMAGE FORMING APPARATUS USING THE SAME

(76) Inventors: Tsuneaki Kondoh, Tokyo (JP); Kyoichi Ashikawa, Tokyo (JP); Takuzo Kurachi, Tokyo (JP); Norihiko Aze, Tokyo (JP); Kohji Kamiya, Tokyo (JP); Takayuki Yoshii, Tokyo (JP); Nozomu Takahata, Eniwa-shi (JP); Atsushi Ishibe, Tokyo (JP); Hidenori Machida, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/877,547

(22) Filed: Oct. 23, 2007

Related U.S. Application Data
(62) Division of application No. 10/784,160, filed on Feb. 24, 2004, now abandoned.

(30) Foreign Application Priority Data
Mar. 13, 2003 (JP) 2003-068661

(51) Int. Cl. G03G 15/30; B05D 1/36; B41M 5/00

(52) U.S. Cl. 399/329; 399/333; 427/145; 427/203

(57) ABSTRACT

In a fixing member having an elastic layer of heat resistance rubber provided on a substrate and a separation layer of fluorocarbon resin provided on the elastic layer, the fluorocarbon resin is that a tensile strength of a 30 μm coating film burned at 340° C. is equal or greater than 25 MPa. The heat resistance rubber includes, for example, silicone rubber or fluorosilicone rubber as a major component. The fluorocarbon resin includes PFA as a major component, for example.

### CROSS-REFERENCE TO RELATED APPLICATIONS

This application is a divisional of U.S. application Ser. No. 10/784,160, filed Feb. 24, 2004, and is based upon and claims the benefit of priority from prior Japanese Patent Application No. 2003-068661, filed Mar. 13, 2003, the entire contents of each of which are incorporated herein by reference.

### BACKGROUND OF THE INVENTION

1. Field of the Invention

The present invention relates to a fixing member such as a roller, a sheet, an endless belt, and the like, that is used in an image forming apparatus such as an electrophotographic copying machine, a laser printer, a facsimile, and the like, furthermore, to an imaging forming apparatus using the same.

2. Description of the Related Art

FIG. 3 is a schematic view illustrating an image forming apparatus of a conventional electrophotographic type. An image forming apparatus of a conventional electrophotographic type 100, for example, a copying machine or a laser printer comprises a photoconductor drum 101 in which an electrostatic latent image is formed, a charging roller 102 for conducting a charging process by contacting to the photoconductor drum 101, an exposure device 103 such as a laser beam, a developing roller 104 for adhering toner to the electrostatic latent image of the photoconductor drum 101, a power pack 105 for applying DC voltage to the charging roller 102, a transfer roller 106 for conducting a process for transferring the toner image on the photoconductor drum 101 onto a recording paper 107, a cleaning device 108 for cleaning the photoconductor drum 101 after the transfer process, a surface electrometer 109 for measuring the surface potential on the photoconductor drum 101, and a roller type thermal fixing device 110 including a thermal fixing roller 111 and a pressurizing roller 112.

The image forming apparatus 100 using the electrophotographic type forms an electrostatic latent image by the exposure of the exposure device 103 such as a laser beam after the photoconductor layer of the rotatable photoconductor drum 101 is uniformly charged by the charging roller 102, and obtains a toner image by developing the electrostatic latent image with toner, and transfers this toner image onto a recording paper 107, then thermally fixes the toner image by passing the recording paper 107 between the roller type thermal fixing device 110 comprising the thermal fixing roller 111 and the pressurizing roller 112.

Such a thermal fixing device of the image forming apparatus 100 uses the thermal fixing roller 111 provided with a separation layer (releasing layer) made of fluorocarbon resin such as Polytetrafluoroethylene resin (PTFE), Tetrafluoroethylene•Perfluoroalkylvinyleter copolymer resin (PFA), and Tetrafluoroethylene•Hexafluoropropylene copolymer resin (EFP) which is covered in order to prevent the adhesion of toner to the outer circumferential surface of the core comprising a metal hollowcylinder body such as aluminum. Heaters such as halogen lamps are disposed parallel to the rotation center line of the hollow space inside the core of the thermal fixing roller 111, enabling the thermal fixing roller 111 to be heated from the inside by the radiation heat emitted from the heaters. The movement of the recording paper 107 between the thermal fixing roller 111 and the pressurizing roller 112 causes the toner on the recording paper 107 to be soften (molten) due to the heat from the thermal fixing roller 11, so that the toner is fixed onto the recording paper 107 with the aid of the pressurizing roller.

The thermal fixing roller 111 having the fluorocarbon resin layer on the core is excellent as for separation ability (releaseability), but is inferior as for both flexibility and elasticity, so that the roller is not suitable for using in a full color copying machine and a full color laser printer which require glossy printing surface. These glossy images of the full color copying machine and the full color laser printer use four types of color toners such as red (magenta), blue (cyan), yellow (yellow), and black (black); however, when a color image is fixed, these color toners are required to be mixed with molten state, and the toners are made fusible at a melting point, and the these toners are also required to be uniformly mixed with the molten state in the state that the several types of toners are wrapped on the surface of the thermal fixing roller.

Accordingly, the flexibility is one of the required features for the surface of the fixing roller.

Taking these facts into account, a thermal fixing roller has been proposed, which is provided an elastic layer comprising heat resistance rubber such as silicone rubber and fluorocarbon rubber onto a core (i.e. substrate), in order to provide the flexibility to the surface layer of such a fixing roller. Providing the elastic layer onto the core enables toner to be uniformly fixed for a black and white image, and also enables several types of color toners to be uniformly molten and mixed for a full color image, so that image quality features such as glossiness and fixing ability are improved.

Moreover, a thermal roller fixing method can maintain the entire heat roller to be a predetermined temperature, and since the heat capacity of the heat roller is large, the method is suitable for increasing a printing speed. However there have been problems which require considerable times for heating the heat roller to the predetermined temperature, and increase the power consumption for heating the entire heat roller.

Consequently, there has been activated an increasing operation to reduce energy, so that reducing the rising time for a heat roller has been studied in recent years. As a measure for the problems, a belt type fixing device was proposed to heat the toner on a recording paper through a film type endless belt heated by a heater.

FIG. 4 is a schematic view illustrating a conventional belt type fixing device. As illustrated in FIG. 4, a conventional electrophotography type image forming apparatus uses a belt type thermal fixing device 120 comprising a fixing belt 113, which is rotatably disposed by a thermal roller 115 and a fixing roller 114, and a pressurizing roller 116 which is disposed so as to be attached to the fixing roller 114 through the fixing belt 113. Such a belt type thermal fixing device 120 lets the recording paper 107 pass between the fixing belt 113 heated by the thermal roller 115 and the pressurizing roller 116, allowing the toner adhered onto the recording paper 107 to be fixed onto the recording paper by softening with the heat of the fixing belt 113 and the pressure with the pressurizing roller 116.

For such a belt type thermal fixing device 120, a thin film type fixing belt 113 is directly heated; enabling its heated portion to achieve to a predetermined temperature within a short time after a power source is turned on. Therefore, it is possible to reduce a waiting time after the power source is turned on. Furthermore, it is advantageous for power consumption because the required portion is only heated.

Conventionally, for this type of fixing belt 113, there has been adopted a fixing belt which comprises an elastic layer (not shown) made of rubber on the surface of a substrate (not shown). For the fixing belt 113, in order to obtain the separation ability, there has been adopted a method of impregnating silicone oil onto the surface. However, this method includes following problems of; (1) requiring user maintenance such as replenishing the silicone oil; (2) increasing a cost for adopting a silicone oil replenishment system; (3) impossibility of writing down with a pen onto a transfer paper because the silicone oil is adhered to the transfer paper. Accordingly, a fixing belt without using the silicone oil has been demanded. As the fixing belt without using the silicone oil, there has been proposed a fixing belt comprising a separation layer onto the surface of the elastic layer of fixing belt. As materials for constituting such a separation layer, the fluorocarbon resin such as Polytetrafluoroethylen resin (PTFE), Tetrafluoroethylene•Perfluoroalkylvinylether copolymer resin (PFA), and Tetrafluoroethylene•Hexafluoropropylene copolymer resin (FEP) have been used.

The fixing member, which is provided the separation layer onto the surface of the elastic layer, i.e. a fixing roller and a fixing belt includes various types. However, in these fixing members, there was a fixing member comprising the elastic layer which was formed by applying heat resistance rubber such as silicone rubber onto the surface of the substrate, and the separation layer which was formed by applying dispersion liquid (water type dispersion paint) or powdered paint including the fluorocarbon resin as the major component, onto the surface of the elastic layer, and by forming a film with heating the dispassion liquid or the powdered paint equal or higher than a melting point. For example, there has been proposed a fixing roller provided with a separation layer which is formed by coating the mixture of fluorocarbon rubber and fluorocarbon resin onto an elastic layer (Japanese Patent Laid-Open S58-5770). There has been also proposed a fixing roller provided with a separation layer which is formed by coating the mixture of fluorocarbon rubber and fluorocarbon resin onto a rubber layer, then by coating fluorocarbon resin paint onto its surface (Japanese Patent Laid-Open S59-217010).

However, the fluorocarbon resin, for example, PFA has its melting point of 310° C., so that in order to obtain the required filming ability, it is required to be burned with a high temperature which is at least 30° C. higher than the melting point. However, if the PFA is burned with such a high temperature, the heat resistance rubber constituting the elastic layer is oxidized and is deteriorated, and the elastic layer is expanded by the heat, so that residual stress is generated on the elastic layer, then a braking (crack) is thereby generated on the separation layer. There is also provided a fixing roller which is applied fluorocarbon resin directly formed onto a metal body onto an elastic layer (Japanese Patent Laid-Open 2000-338810), but such a fixing roller also has a crack on the surface layer.

As described above, if the crack is generated on the separation layer, toner is remained in the crack, so that there was a problem to generate an image fixing defect caused by an image smear and unevenness for a surface.

In addition, if loads caused by jamming for a transfer paper, contact for a separation pawl, and the like are generated on the crack, only the separation layer is peeled off, so that the molten toner can not be separated. Therefore, there was a problem of emitting smoke or catching fire which was caused by winding of a transfer paper to the fixing roller.

A fixing member which avoided the generation of crack on the separation layer includes a fixing roller obtained by casting heat resistance rubber into a fluorocarbon resin tube (Japanese Patent Laid-Open H7-334024). Such a fixing roller is manufactured by use of the fluorocarbon resin tube which is manufactured separately, enabling the heat resistance rubber comprising the elastic layer to be prevented from the deterioration, but there is a limit to the extent to which the thickness of the fluorocarbon resin tube can be reduced. For the fixing roller which is manufactured by this method, the flexibility of the above required feature is lost by the influence of thick and hard fluorocarbon resin layer, so that there has been a problem to generate a defect such as unevenness of glossiness.

### SUMMARY OF THE INVENTION

It is an object of the present invention to solve the above described problems. That is, with the object of providing with a low cost, the object of the present invention is to provide, a fixing member without having defects such as an image smear, an image fixing defect, unevenness of glossiness, and winding of a transfer paper, which are caused by a crack in a separation layer generated by oxidation and deterioration of a heat resistance rubber for an elastic layer inside a separation layer, when a film of fluorocarbon resin is formed by burning the fluorocarbon resin of the separation layer at a low temperature, and an image forming apparatus using the same.

In order to achieve the above described object, according to the present invention, in a fixing member comprising an elastic layer made of heat resistance rubber provided onto a substrate and a separation layer made of fluorocarbon resin provided onto the elastic layer, the fluorocarbon resin is that a tensile strength of a 30 μm coating film burned at 340° C. is equal or greater than 25 MPa.

Moreover, in the present invention, a manufacturing method of a fixing member comprises the steps of forming a first primer layer by applying first primer onto a substrate, forming an elastic layer by applying heat resistance synthetic rubber solution onto the first primer layer, forming a second primer layer by applying second primer onto the elastic layer, forming a fluorocarbon resin applied layer by applying dispersion liquid or powdered paint including fluorocarbon resin with which a tensile strength of a 30 μm coating film burned at 340° C. is equal or greater than 25 MPa as a major component onto the second primer layer, and burning the fluorocarbon resin applied layer with a burning temperature which is equal or higher than 340° C. and less than a temperature for starting the oxidation of the heat resistance synthetic rubber constituting the elastic layer.

Furthermore, in the present invention, a manufacturing method of an image forming apparatus comprises the steps of forming a first primer layer by applying first primer onto a substrate, forming an elastic layer by applying heat resistance synthetic rubber solution onto the first primer layer, forming a second primer layer by applying second primer onto the elastic layer, forming a fluorocarbon resin applied layer by applying dispersion liquid or powdered paint including fluorocarbon resin with which a tensile strength of a 30 μm coating film burned at 340° C. and also less than a temperature for starting the oxidation of the heat resistance synthetic rubber constituting said elastic layer, and incorporating the fixing member obtained by the steps into an image forming apparatus.

### BRIEF DESCRIPTION OF THE DRAWINGS

FIG. 1A is a cross sectional view of fixing roller illustrating an embodiment of the present invention.

FIG. 1B is an enlarged sectional view illustrating the part surrounded by the dotted line in FIG. 1A.

FIG. 2 is a sectional view of fixing belt illustrating another embodiment of the present invention.

FIG. 3 is a schematic view illustrating an image forming apparatus of conventional electrophotographic type.

FIG. 4 is a schematic view illustrating a fixing device of conventional belt type.

### DESCRIPTION OF THE PREFERRED EMBODIMENTS

Next, embodiments of the present invention will be described based on the accompanying views.

There has been well known in the field that a tensile strength of (1) Tetrafluoroethylene•Perfluoroalkylvinylether copolymer resin (PFA) is different based on the copolymer ratio of the Perfluoroalkylvinylether which is the copolymer components of PFA, and a tensile strength of (2) Tetrafluoroethylene•Hexafluoropropylene copolymer resin (FEP) is also different based on the copolymer ratio of the Hexafluoropropylene which is the copolymer components of FEP. Moreover, the present inventors selected fluorocarbon resin that a tensile strength (breaking time) of a 30 μm coating film burned at 340° C. is equal or greater than 25 MPa from the above described fluorocarbon resin, then adopted the selected fluorocarbon resin as the fluorocarbon resin for a separation layer in a fixing member having an elastic layer of heat resistance rubber provided onto a substrate and the separation layer provided on the elastic layer. When the film of the fluorocarbon resin was formed by burning the fluorocarbon resin of the separation layer with a low temperature, a fixing member without having defects such as an image smear, an image fixing defect, unevenness of glossiness, and winding of a transfer paper, which are caused by a crack in the separation layer generated by the oxidation and the deterioration of the heat resistance rubber of the elastic layer inside the separation layer, and an image forming apparatus using the fixing member were found to be provided with a low cost by the present inventors. Accordingly, the present inventors completed the present invention.

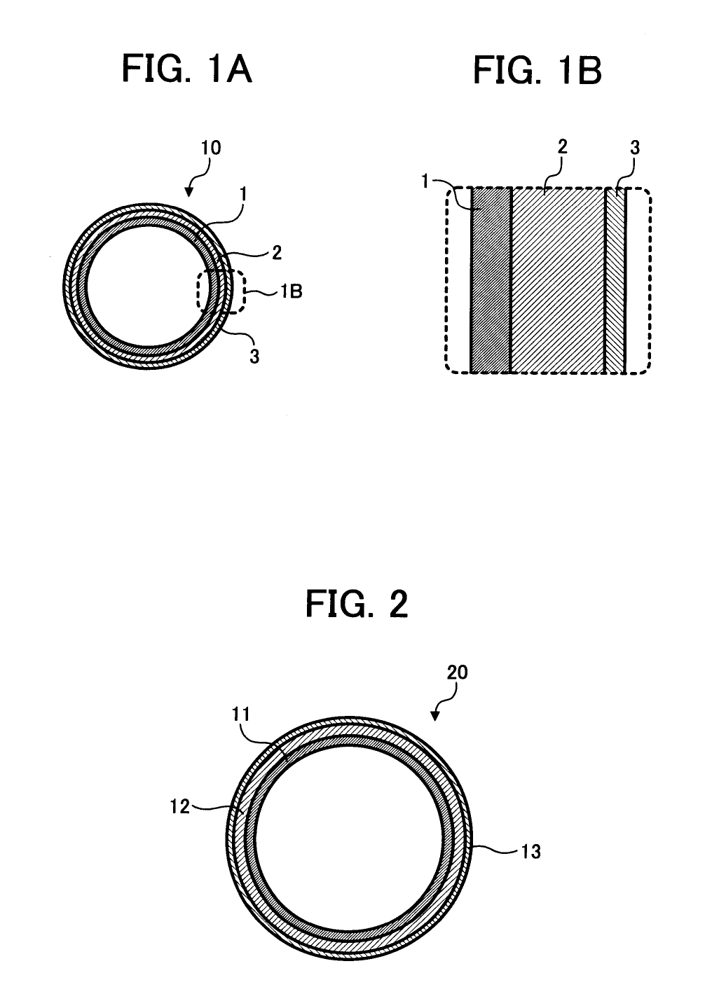

In FIG. 1, a reference numeral 10 denotes a fixing roller (fixing member) of the present invention. The fixing roller 10 is provided with an elastic layer 2 made of heat resistance rubber disposed onto a substrate 1 and a separation layer 3 made of fluorocarbon resin disposed onto the elastic layer 2. The fluorocarbon resin is that the tensile strength (braking time) (hereinafter referred to as tensile strength) of the 30 μm coating film burned at 340° C. is equal or greater than 25 MPa. The tensile strength was measured at 23° C. in a tensile speed of 10 mm/min by using a 10 mm wide test piece which was formed after the only separation layer was formed on an aluminum metal plate by the fluorocarbon resin constituting the separation layer, then the separation layer was peeled off as the 10 mm wide test piece.

In FIG. 2, a reference numeral 20 denotes a fixing belt (fixing member) of the present invention. The fixing belt 20 is provided with an elastic layer 12 made of heat resistance rubber provided on a substrate 11 constituting an endless belt and a separation layer 13 made of fluorocarbon resin provided on the elastic layer 12. The fluorocarbon resin is that the tensile strength (breaking time) of the 30 μm coating film burned at 340° C. is equal or greater than 25 MPa as same as the above described fixing roller (fixing member). Like the above described fixing roller (fixing member), the fluorocarbon resin is that the tensile strength (breaking time) of the 30 μm coating film burned at 340° C. is equal or greater than the 25 MPa; the tensile strength was measured at 23° C. a tensile speed of 10 mm/min by using a 10 mm wide test piece which was formed after the only separation layer was formed on an aluminum metal plate by the fluorocarbon resin of the separation layer, then the separation layer was peeled off as the 10 mm wide test piece.

According to the present invention as described above, the fluorocarbon resin constituting the separation layers 3 and 13 has the tensile strength, i.e. the tensile strength (breaking time) of the 30 μm coating film burned at 340° C. is equal or greater than 25 MPa; therefore, when the film of the fluorocarbon resin is formed by burning the fluorocarbon resin of the separation layer at a low temperature (for example, 340° C.), the fixing member without having the defects such as an image smear, an image fixing defect, unevenness of glossiness, and winding of a transfer paper, which are caused by the crack in the separation layers 3 and 13 generated by the oxidization and the deterioration of the heat resistance rubber of the elastic layers 2 and 12 inside the separation layers, can be provided with a low cost.

The heat resistance rubber constituting the elastic layers 2 and 12 has a fixing temperature of 200° C., so it is preferable for the heat resistance rubber to include a major component of silicone rubber or fluorosilicone rubber having heat resistance which can resist the temperature. However, another heat resistance rubber, which can resist the above temperature, can be used in addition to the above described heat resistance rubber, as long as the object of the present invention is maintained. As described above, adopting the heat resistance rubber of the elastic layers 2 and 12 having the silicone rubber or the fluorosilicone rubber as the major component, the heat deterioration of the rubber is reduced, the deterioration of the image quality caused by increasing hardness is prevented, and then an excellent image can be obtained.

The fluorocarbon resin of the separation layers 3 and 13 is that the tensile strength (breaking time) of the 30 μm coating film burned at 340° C. is equal or greater than 25 MPa, and preferably, the fluorocarbon resin is selected from the type of the copolymer of Tetrafluorethylene•Perfluoroalkylvinylether copolymer resin (PFA). Such PFA is already available in the market as resin for molding (Du Pont-Mitsui Fluorochemicals Company, Ltd., TEFLON (registered trademark), 340J (pellet member); furthermore, in the present invention, powdered fluorocarbon resin is used by mixing the above mentioned PFA and carbon powder (#50, Asahi Carbon, Co., Ltd). Moreover, it is also possible for the fluorocarbon resin of separation layers 3 and 13 to be selected from the type of copolymer of Tetrafluoroethylene•Hexafluoroproplene copolymer resin (FEP).

In the present invention, the separation layers 3 and 13 may contain inorganic filler. Such inorganic filler is preferably carbon. If the inorganic filler is contained in the separation layers 3 and 13, the abrasion resistance of the fixing members 10 and 20 may be obtained, contributing to the long operating life of the fixing members 10 and 20. If the inorganic filler is carbon, the slipping performance of the fixing member may also be obtained.

According to the present invention, the content of the carbon is preferably from 1 mass % to 5 mass %. If the content of the carbon is from 1 mass % to 5 mass %, the smoothness on the surface of the fixing members 10 and 20 is obtained, enabling the secondary process on the surface to be omitted. Therefore, the manufacturing cost of the fixing members 10 and 20 can be reduced, and its coating film can be stabilized. Moreover the defects such as an image smear caused by remained toner and an image fixing defect caused by the unevenness of the surface can be prevented, and then an excellent image can be obtained.

The substrate 1 is a cylindrical roller, preferably being made of a metal member such as aluminum, stainless still, brass, iron, and the like. The substrate 11, is (a) a sheet or an endless belt, preferably being made of a metal member such as stainless still, nickel, and the like, (b) a sheet or an endless belt, preferably being made of heat resistance resin such as polyimide, polyamideimide, and the like, or (c) a laminated sheet or an endless belt in which (a) and (b) are laminated. It is preferable for the laminated sheet or the endless belt to have a film thickness of 100 μm, taking its flexibility into consideration. It is also preferable for the heat resistance resin to have a film thickness of from 20 to 200 μm taking the reduction of heating time for starting up the sheet or the belt and the film thickness into consideration. Moreover, it is preferable for the endless belt to be a seamless belt without a seam. If the substrate 1 is a seamless belt, the surface can be formed more smoothly, and an excellent image can be obtained.

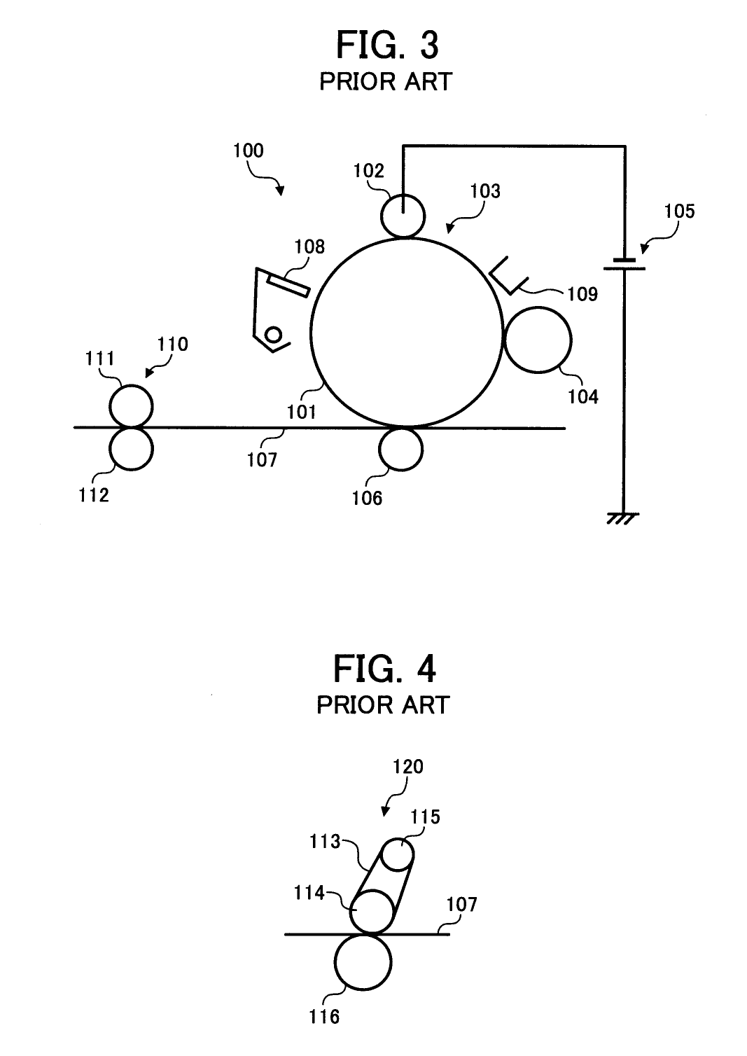

The fixing member of the present invention can be disposed in an image forming apparatus illustrated in FIGS. 3 and 4, for example. In such a case, the fixing member of the present invention can be used instead of using the fixing roller 111 or the fixing belt 113. The image forming apparatus of the present invention comprises the fixing member of the present invention; therefore, it is possible to provide the image forming apparatus without including the defects such as an image smear, an image fixing defect, unevenness of glossiness, winding of a transfer paper, and the like, with a low cost; furthermore, the image forming apparatus has a small number of unit exchange frequencies, a long operating life, and high reliability.

The fixing member of the present invention is manufactured by sequentially going through the following processes.

A first process for forming a first primer layer by applying first primer onto a substrate; a second process for forming an elastic layer by applying heat resistance synthetic rubber solution onto the first primer layer; a third process for forming a second primer layer by applying second primer onto the elastic layer; a fourth process for forming a fluorocarbon resin applied layer by applying dispersion liquid or powdered paint having the major component of the fluorocarbon resin, with which a tensile strength of a 30 μm coating film burned at 340° C. is equal or greater than 25 MPa, onto the second primer layer; and a fifth process for burning the fluorocarbon resin applied layer with a burning temperature which is a temperature of equal or greater than 340° C., and also does not exceed a temperature for starting the oxidation of the heat resistance synthetic rubber of the elastic layer.

The manufacturing method of the fixing member of the present invention includes the fourth process, that is, the process for forming the fluorocarbon resin applied layer by applying the dispersion liquid or the powdered paint having the major component of the fluorocarbon resin with which the tensile strength (breaking time) of the 30 μm coating film burned at 340° C. is equal or greater than 25 MPa; therefore, when the film of the fluorocarbon resin is formed by burning the fluorocarbon resin constituting the separation layer with a low temperature (for example, 340° C.), the fixing member without having the defects such as an image smear, an image fixing defect, unevenness of glossiness, and winding of a transfer paper which are caused by the crack in the separation layer generated by the oxidization and the deterioration of the heat resistance rubber of the elastic layer inside the separation layer, can be provided with a low cost. The tensile strength of the fluorocarbon resin was measured at 23° C. in a tensile speed of 10 mm/min by using a 10 mm wide test piece which was formed after the only separation layer was formed onto an aluminum metal plate by the fluorocarbon resin of the separation layer, then the separation layer was peeled off as the 10 mm wide test piece. The heat resistance synthetic rubber solution used in the second process of the manufacturing method of the fixing member can be selected within a scope which does not depart from the object of the invention. However, the fixing temperature is 200° C., so it is preferable to use silicone rubber or fluorosilicone rubber having heat resistance which resists the temperature. If the heat resistance synthetic rubber solution includes the silicone rubber or the fluorosilicone rubber as the major component, the heat deterioration of the rubber is reduced, the image deterioration caused by increasing hardness is prevented, and an excellent image can be obtained.

The fluorocarbon resin which is the major component of the dispersion liquid or the powdered paint used in the fourth process of manufacturing method of the fixing member is that the tensile strength (breaking time) of the 30 μm coating film burned at 340° C. is equal or greater than 25 MPa, but preferably, may be selected from the type of the copolymer of Tetrafluoroethylen•Perfluoroalkylvinylether copolymer resin (PFA). Moreover, the fluorocarbon resin may be selected from the type of the copolymer of Tetrafluoroethylene•Hexafluoropropylene copolymer resin (FEP). Furthermore, the dispersion liquid or the powdered paint may contain inorganic filler. Such inorganic filler is preferably carbon. Accordingly, if the dispersion liquid or the powdered paint contains the inorganic filler, the manufactured fixing member can obtain the abrasion resistance. Consequently, the long operating life of the manufactured fixing member can be contributed. If the inorganic filler is carbon, the slipping performance for the fixing member can be obtained.

The content of the carbon is preferably from 1 mass % to 5 mass %. If the content of the carbon is from 1 mass % to 5 mass %, the smoothness on the surface of the fixing member manufactured by the manufacturing method of the fixing member can be obtained, enabling the secondary process of the surface to be omitted. Therefore, the manufacturing cost of the fixing member can be reduced, and the coating film of the fixing member can be stabilized.

The substrate used in the first process of the manufacturing method of the fixing member is preferably a cylindrical roller made of a metal member such as aluminum, stainless still, brass, iron, and the like. It is also suitable for the substrate to use (a) a sheet or an endless belt made of a metal member such as stainless still, nickel, and the like (b) a sheet or an endless belt made of heat resistance resin such as polyimide, polyamideimide, and the like, or (c) the laminated sheet or an endless belt in which (a) and (b) are laminated. It is preferable for the laminated sheet or the endless belt to have a film thickness of 100 μm taking its flexibility into the consideration. It is also preferable for the heat resistance resin to have a film thickness from 20 μm to 200 μm regarding the reduction of heating time for starting up the sheet or the belt and the film thickness. The endless belt is preferably to be a seamless belt without a seam. If the substrate is the seamless belt, the surface can be formed more smoothly, and an excellent image can be obtained.

The manufacturing method of the image forming apparatus of the present intention has a characteristic to comprise a sixth process for incorporating the fixing member obtained by the processes from first to the fifth process into the thermal fixing part for an image forming apparatus. The fixing member obtained by the processes from the first to the fifth can be incorporated into the thermal fixing device (thermal fixing part) of the image forming apparatus illustrated in FIGS. 3 and 4, for example. More specifically, the image forming apparatus may be manufactured by disposing the fixing member obtained by the processes from the first to the fifth instead of using the fixing roller 111 or the fixing belt 113.

In the manufacturing method of the image forming apparatus, the fourth process, that is the process for forming the fluorocarbon resin applied layer by applying the dispersion liquid or the powdered paint having the major component of the fluorocarbon resin with which the tensile strength (braking time) of the 30 μm coating film burned at 340° C., onto the second primer layer is included. Consequently, for the fixing member incorporated into the thermal fixing part, when the film of the fluorocarbon resin is formed by burning the fluorocarbon resin of the separation layer at a low temperature (for example, 340° C.), the crack on the separation layer generated by the oxidization and the deterioration of the heat resistance rubber comprising the elastic layer inside the separation layer is not generated. Accordingly, a highly reliable image forming apparatus which does not have the defects such as an image smear, an image fixing defect, unevenness of glossiness, and winding of a transfer paper, and also which has a small number of unit exchange frequencies and a long operating life.

### Embodiments

### First Embodiment

A fixing roller (fixing member) is obtained in accordance with the order of the following processes. A first process for forming a first primer layer by applying primer (Dow Corning Toray Silicone DY39-051) onto a core made of aluminum with a diameter of 40 mm, and drying the applied layer; a second process for forming an elastic layer by applying the solution of the heat resistance silicone resin (Dow Corning Toray Silicone DX35-2083) with a coating thickness of 250 μm onto the first primer layer, then by curing the silicone resin; a third process for forming a second primer layer by applying liquid primer for silicone containing the fluorocarbon resin (Du Pont-Mitsui Fluorochemicals Company, Ltd) onto the elastic layer, and by drying the layer; a fourth process for forming a 30 μm applied layer with a thickness of 30 μm by applying dispersion liquid containing the powdered fluorocarbon resin which is mixed Tetrafluoroethylene•Perfluoroalkylvinylether copolymer resin (PFA) (Du Pont-Mitsui Fluorochemicals Company, Ltd., TEFLON (registered trademark) 340J (pellet member)) with a tensile strength of 25 MPa and carbon powder (Asahi Carbon, Co., Ltd., #50) on the second primer layer, and by drying the layer; a fifth process for forming the separation layer by burning the applied layer at 340° C. for 30 minutes.

In this first embodiment, the content of the carbon powder in the fourth process is adopted to be 1 mass %.

The temperature for starting the oxidation of the heat resistance silicone resin (Dow Corning Toray Silicone, Co., Ltd., DX35-2083) as the heat resistance synthetic rubber is equal or higher than 330° C.

### Second Embodiment

A fixing roller was obtained in the same way as the first embodiment, in addition to the use of the carbon powder with a content of 3 mass % in the fourth process of the first embodiment.

### Third Embodiment

A fixing roller was obtained in the same way as the first embodiment, in addition to the use of the carbon powder with a content of 5 mass % in the fourth process of the first embodiment.

### Fourth Embodiment

A fixing roller was obtained in the same way as the first embodiment, in addition to the use of molten silica powder of 3 mass % instead of using the carbon powder of 1 mass % in the fourth process of the first embodiment.

### Fifth Embodiment

A fixing roller was obtained in the same way as the first embodiment, in addition to the use of molten silica powder of 5 mass % instead of using the carbon powder of 1 mass % in the fourth process of the first embodiment.

### Sixth Embodiment

A fixing roller was obtained in the same way as the first embodiment, in addition to the use of the applied layer burned at 360° C. for 30 minutes in the fourth process of the first embodiment.

### Seventh Embodiment

A fixing roller was obtained in the same way as the first embodiment, in addition to the use of carbon powder with a content of 3 mass % and the applied layer burned at 360° C. for 30 minutes in the fourth process of the first embodiment.

### Eighth Embodiment

A fixing roller was obtained in the same way as the first embodiment, in addition to the use of carbon powder with a content of 5 mass % and the applied layer burned at 360° C. for 30 minutes in the fourth process of the first embodiment.

### COMPARATIVE EXAMPLE 1

A fixing roller was obtained in the same way as the first embodiment, in addition to the use of the applied layer burned at 330° C. for 30 minutes in the fourth process of the first embodiment.

### COMPARATIVE EXAMPLE 2

A fixing roller was obtained in the same way as the first embodiment, in addition to the use of carbon powder with a content of 3 mass % and the applied layer burned at 330° C. for 30 minutes in the fourth process of the first embodiment.

### COMPARATIVE EXAMPLE 3

A fixing roller was obtained in the same was as the first embodiment, in addition to the use of the separation layer that the 30 μm applied layer is formed by applying the dispersion liquid including the powdered mixture of Tetrafluoroethylene•Perfluoroalkylvinylether copolymer resin (PFA) (Du Pont-Mitsui Fluorochemicals Company, Ltd., MP102 (pellet member)) with a tensile strength of 25 MPa and carbon powder (Asahi Carbon, Co., Ltd., #50) onto the second primer layer and by drying the applied layer, then is burned the applied layer at 340° C. for 30 minutes in the fourth process of the first embodiment.

### COMPARATIVE EXAMPLE 4

A fixing roller was obtained in the same way as the first embodiment, in addition to the use of carbon powder with a content of 3 mass % in the comparative example 1.

### COMPARATIVE EXAMPLE 5

A fixing roller was obtained in the same way as the first embodiment, in addition to the use of carbon powder with a content of 5 mass % in the comparative example 1.

Following evaluation items were evaluated for the fixing rollers (fixing members) which were obtained in the embodiments from 1 to 8 and the comparative examples 1 to 5.
(1) Filming ability

The external appearance of the fixing roller (fixing member) was evaluated whether a film was formed or not, adopting ◯, if the film was formed, and adopting X, if the film was not formed.
(2) With or without crack on the separation layer

The separation layer after burning was evaluated whether a crack on the layer was included or not, adopting ◯, if the layer did not include the crack, and adopting X, if the layer included the crack.
(3) With or without fixing of toner

The fixing roller was evaluated whether an image defect is included or not through 10 k recording papers, adopting ◯, if toner was not fixed, and adopting X, if toner was fixed.
(4) Abrasion ability

The fixing roller was evaluated as 5 levels from 1 to 5 by the abrasion amount of separation pawl contacting part for 150 k recording papers, adopting the fixing roller with an evaluation 3 or higher as a practicable roller, and adopting the fixing roller with an evaluation 2 or under as an impracticable roller.

Evaluation results are indicated in the following table 1, and * in the table 1 indicates impossibility of the evaluation.

TABLE 1

| | | With or | | |
|---|---|---|---|---|
| | | without | With or | |
| | | crack on | without | |
| | Filming | separation | fixing of | Abrasion |
| | ability | layer | toner | ability |
| First Embodiment | ◯ | ◯ | ◯ | 3 |
| Second Embodiment | ◯ | ◯ | ◯ | 4 |
| Third Embodiment | ◯ | ◯ | ◯ | 5 |
| Forth Embodiment | ◯ | ◯ | ◯ | 3 |
| Fifth Embodiment | ◯ | ◯ | ◯ | 3 |
| Sixth Embodiment | ◯ | ◯ | ◯ | 3 |
| Seventh Embodiment | ◯ | ◯ | ◯ | 4 |
| Eighth Embodiment | ◯ | ◯ | ◯ | 5 |
| Comparative Example 1 | X | * | * | * |
| Comparative Example 2 | X | * | * | * |
| Comparative Example 3 | ◯ | X | ◯ | 3 |
| Comparative Example 4 | ◯ | X | ◯ | 4 |
| Comparative Example 5 | ◯ | X | ◯ | 5 |

According to the invention on the fixing member, the fluorocarbon resin constituting the separation layer is that the tensile strength (breaking time) of the 30 μm coating film burned at 340? is equal or greater than 25 MPa, so that when the film of the fluorocarbon resin is formed by burning the fluorocarbon resin of the separation layer with a low temperature (for example, 340° C.), the fixing member without defects such as an image smear, an image fixing defect, unevenness of glossiness, and winding of a transfer paper which are caused by the crack on the separation layer generated by the oxidization and the deterioration of heat resistance rubber of the elastic layer inside the separation layer can be provided with a low cost.

According to the invention on the fixing member, the heat resistance rubber constituting the elastic layer includes the silicone rubber or the fluorosilicone rubber as the major component, enabling the heat deterioration of the rubber to be reduced, the image quality deterioration by increasing hardness to be prevented, and an excellent image quality to be obtained.

According to the invention on the fixing member, the separation layer contains the inorganic filler, enabling abrasion resistance to be obtained for the fixing member. Therefore, a long operating life for the fixing member can be provided.

According to the invention on the fixing member, the inorganic filler is carbon, enabling the slipping performance on the fixing member to be obtained.

According to the invention on the fixing member, the content of the carbon is from 1 mass % to 5 mass %, so that the smoothness on the surface of the fixing member can be obtained. Therefore the secondary process on the surface can be omitted, allowing the reduction of manufacturing cost of the fixing member, and the stabilization of the coating film. Moreover, the defects such as an image smear caused by remained toner and an image fixing defect caused by unevenness of a surface can be prevented, then an excellent image can be obtained.

According to the invention on the image forming apparatus, the image forming apparatus comprises the above described fixing member, so that the highly reliable image forming apparatus, which does not include the defects such as an image smear, an image fixing defect, unevenness of glossiness, and winding of a transfer paper, furthermore has a small number of unit exchange frequencies and a long operating life can be provided with a low cost.

According to the invention on the manufacturing method, the process for forming the fluorocarbon applied layer by applying the dispersion liquid or the powdered paint, which includes the fluorocarbon resin having the melting point 20° C. equal or higher than the temperature for starting the oxidation of the heat resistance synthetic rubber constituting the elastic layer, onto the second primer layer is provided, so that the fixing member without having the defects such as an image smear, an image fixing defect, unevenness of glossiness, winding of transfer paper, and the like, which are caused by the crack on the separation layer generated by the oxidation and the deterioration of the heat resistance synthetic rubber constituting the elastic layer inside the separation layer, is provided with a low cost, when the film of the fluorocarbon resin is formed by burning the fluorocarbon resin constituting the separation layer with a low temperature (for example 340° C.).

What is claimed is:

1: A fixing member including a substrate, an elastic layer including heat resistance rubber provided on the substrate, and a separation layer including fluorocarbon resin provided on said elastic layer, said elastic layer including silicone rubber and/or fluorosilicone rubber as a major component, the fixing member made by a method comprising:
baking the separation layer on the elastic layer at a temperature lower than an oxidation starting temperature of the heat resistance rubber such that said heat resistance rubber in said elastic layer does not oxidize and said separation layer does not crack,
wherein said fluorocarbon resin has a tensile strength such that a 30 μm coating film baked at 340° C. has a tensile strength equal to or greater than 25 MPa.

2: The fixing member according to claim 1, wherein said baking the separation layer includes baking said fluorocarbon resin including Tetrafluoroethylene•Perfluoroalkylvinylether copolymer resin (PFA) as a major component.

3: The fixing member according to claim 1, wherein said baking the separation layer includes baking said separation layer containing inorganic filler.

4: The fixing member according to claim 3, wherein said baking the separation layer includes baking said separation layer containing said inorganic filler including carbon.

5: The fixing member according to claim 4, wherein said baking the separation layer includes baking said separation layer containing said inorganic filler including a content of said carbon from 1 mass % to 5 mass %.

6: The fixing member according to claim 1, wherein said substrate is a roller made of a metal member including aluminum, stainless steel, brass, or iron.

7: The fixing member according to claim 1, wherein said substrate is (a) a sheet or an endless belt made of a metal member including stainless steel, or nickel, (b) a sheet or an endless belt made of heat resistance rubber including polyimide or polyamideimide, or (c) a laminated sheet or an endless belt in which said (a) and (b) are laminated.

8: An image forming apparatus comprising the fixing member according to claim 1.

9: A manufacturing method of a fixing member comprising:
forming a first primer layer by applying first primer onto a substrate surrounding an aperture configured to receive a heater;
forming an elastic layer by applying heat resistance synthetic rubber solution onto said first primer layer, said elastic layer including silicone rubber and/or fluorosilicone rubber as a major component, said elastic layer not including any oxidized heat resistance synthetic rubber solution;
forming a second primer layer by applying second primer onto said elastic layer;
forming a fluorocarbon resin applied layer by applying dispersion liquid or powdered paint including fluorocarbon resin with which a tensile strength of a 30 μm coating film burned at 340° C. is equal or greater than 25 MPa as a major component onto said second primer layer, said fluorocarbon resin applied layer not including any cracks; and
baking said fluorocarbon resin applied layer with a baking temperature which is equal or higher than 340° C. and less than a temperature for starting oxidation of the heat resistance synthetic rubber constituting said elastic layer such that the elastic layer is not oxidized and cracks are not formed in the fluorocarbon resin applied layer.

10: The manufacturing method of the fixing member according to claim 9, wherein said fluorocarbon resin comprises Tetrafluoroethylene•Perfluoroalkylvinylether copolymer resin (PFA).

11: The manufacturing method of the fixing member according to claim 9, wherein said dispersion liquid or said powdered paint contains inorganic filler.

12: The manufacturing method of the fixing member according to claim 11, wherein said inorganic filler comprises a carbon.

13: The manufacturing method of the fixing member according to claim 12, wherein a content of said carbon is from 1 mass % to 5 mass %.

14: The manufacturing method of the fixing member according to claim 9, wherein said substrate is a roller made of a metal member including aluminum, stainless still, brass, or iron.

15: The manufacturing method of the fixing member according to claim 9, wherein said substrate is (a) a sheet or an endless belt made of a metal member including stainless still or nickel, (b) a sheet or an endless belt made of a metal member including polyimide or polyamideimide, or (c) a laminated sheet or an endless belt in which said (a) and (b) are laminated.

16: A manufacturing method of an image forming apparatus comprising:
forming a first primer layer by applying first primer onto a substrate surrounding an aperture configured to receive a heater;
forming an elastic layer by applying heat resistance synthetic rubber solution onto said first primer layer, said elastic layer including silicone rubber and/or fluorosilicone rubber as a major component, said elastic layer not including any oxidized heat resistance synthetic rubber solution;
forming a second primer layer by applying second primer onto said elastic layer;
forming a fluorocarbon resin applied layer by applying dispersion liquid or powdered paint including fluorocarbon resin with which a tensile strength of a 30 μm coating film burned at 340° C. is equal or greater than 25 MPa as a major component onto said second primer layer, said fluorocarbon resin applied layer not including any cracks;
baking said fluorocarbon resin applied layer with a baking temperature which is equal or higher than 340° C. and less than a temperature for starting oxidation of the heat resistance synthetic rubber constructing said elastic layer such that the elastic layer is not oxidized and cracks are not formed in the fluorocarbon resin applied layer; and
incorporating the fixing member obtained by said steps into an image forming apparatus.
